(19) United States
(12) Patent Application Publication
(10) Pub. No.: US 2022/0009308 A1
(43) Pub. Date: Jan. 13, 2022

(54) THERMAL MANAGEMENT SYSTEM FOR A MOTOR VEHICLE PASSENGER COMPARTMENT

(71) Applicant: Valeo Systemes Thermiques, Le Mesnil-Saint-Denis Cedex (FR)

(72) Inventors: Daniel Neveu, Le Mesnil Saint-Denis Cedex (FR); Georges De Pelsemaeker, Le Mesnil Saint Denis Cedex (FR)

(73) Assignee: Valeo Systemes Thermiques, Le Mesnil-Saint-Denis Cedex (FR)

(21) Appl. No.: 17/291,925

(22) PCT Filed: Nov. 7, 2019
(86) PCT No.: PCT/FR2019/052655

§ 371 Date: May 6, 2021

(30) Foreign Application Priority Data
Nov. 9, 2018 (FR) 1860337

(51) Int. Cl. B60H 1/00

(52) U.S. Cl. CPC B60H 1/00742; B60H 1/00878; B60H 1/0073

(57) ABSTRACT

The invention relates to a thermal management system for a motor vehicle passenger compartment, the system comprising a processing unit arranged to: determine two terms that make up a thermal comfort index (TCI) value related to the passenger in the passenger compartment, one of the terms being a stationary term (TCIs) which is representative of the heat exchanges needed to keep the passenger in a state of stabilized thermal comfort, in particular obtained using a thermo-physiological model, in particular using the data representing (MET) the metabolic activity of the passenger. the other term being a dynamic term (TCId) representing one or more local and transitory imbalances of the thermal comfort state of the passenger, which are the result of: either a recent thermal stress experienced by the passenger, or a thermal stimulus intended to achieve a pleasant temporary sensation of heat or cold.

The invention relates to a motor-vehicle thermal management system. The invention further relates to a thermal management method implemented by such a thermal management system.

As a general rule, in order to monitor and/or predict the thermal comfort of a passenger in the vehicle, it is necessary to estimate the person's metabolic activity, by using a datum (MET) representative of the metabolic activity as the input datum of a thermophysiological model. This model will make it possible to evaluate simultaneously the thermal sensations and the thermal comfort of the person. The thermal sensation is the expression of a global or local thermal perception of the person, for example hot, neutral or cold. The expression “thermal neutrality” is used if the thermal sensation experienced is “neither hot nor cold”. The thermal comfort is the expression of the person's satisfaction with respect to this thermal perception, for example pleasant or unpleasant, on the basis of the person's requirements of hot and cold, and also on the basis of the person's thermal history.

The invention is intended to improve thermal management in a vehicle interior or a cockpit.

Thus the invention relates to a thermal management system for a motor vehicle interior, the system comprising a processing unit arranged for:
preferably, determining a datum (MET) representative of the passenger's metabolic activity, notably by using an infrared sensor aimed toward the passenger,
determining two terms making up a value of a thermal comfort index (TCI) associated with this passenger in the interior,
   one of the terms being a fixed term (TCIs) representative of the heat exchanges required to maintain a stabilized state of thermal comfort in the passenger, with the aim of achieving thermal neutrality at the global and local level, notably obtained by means of a thermophysiological model, using, notably, the datum (MET) representative of the passenger's metabolic activity.
   the other of the terms being a dynamic term (TCId) representative of one or more local transient imbalances of the passenger's state of thermal comfort, resulting, notably, from:
a recent thermal stress to which the passenger has been subjected,
a thermal stimulus intended to provide a pleasant temporary sensation of heat or cold, particularly in order to compensate for a thermal stress as described above.
determining the value of a thermal comfort index (TCI) on the basis of the two terms thus determined,
controlling one or more thermal actuators on the basis of this thermal comfort index value.

According to an aspect of the invention, the fixed term tends toward zero when a state of thermal neutrality is achieved for the passenger, a comfort state being characterized by the absence of any thermal sensation, that is to say neither heat nor cold, at both the global and the local level, and associated, notably, with the long-term maintenance of comfort.

Notably, the fixed term does not take the thermal history of the passenger into account, particularly the effect in time of a previous thermal imbalance due to the thermal inertia of the body.

According to an aspect of the invention, the dynamic term is representative of a state in which the passenger has been, or is being, subjected to a transient thermal stress or stimulus. In some cases, this will be a thermal stress that is perceived as uncomfortable and unpleasant, while in other cases it will be a thermal stimulus that is perceived as comfortable and pleasant.

The dynamic term may be used to evaluate the effect of thermophysiological mechanisms outside a balanced state. Depending on the nature of the term (stress or stimulus, uncomfortable or comfortable), it will be taken into account differently in the calculation of the comfort index (TCI).

According to an aspect of the invention, the thermal stress or stimulus in question is associated with a situation chosen from the following, among others:
a recent prior event, for example a journey on foot that has just ended, or a walk in a very cold environment,
a sudden variation in the thermal environment; for example, the passenger enters an overheated vehicle in the summer, or the sun suddenly shines on the passenger's head,
a thermal stress due to a psychophysiological shock, for example when the passenger has just avoided an accident.

The present invention is intended to provide a solution for better identification and management of these different situations over time, on the basis of signs in a person that can be detected and interpreted.

According to an aspect of the invention, the system is arranged for estimating a value of a comfort index for all the passengers in a vehicle, using an infrared camera, notably a plurality of infrared cameras.

According to an aspect of the invention, this camera is an infrared camera operating in the near infrared (Near Infra Red camera) or operating in the far infrared (Far Infra Red).

According to an aspect of the invention, the evaluation of a person's metabolism is carried out by measuring vital signs of this person.

According to an aspect of the invention, the thermal comfort index (TCI) is formulated so that comfort is maximal when the value of the index (TCI) is equal to zero.

According to an aspect of the invention, the global comfort index TCI is defined on the basis of two terms, namely a fixed term TCIs and a dynamic term TCId, notably by the weighted sum of the two terms using two coefficients A and B:

TCI=[A.TCIs+B.TCId]

According to an aspect of the invention, the comfort index may be expressed by the fixed term dynamic term, while said dynamic term may be amplified to accelerate the convergence on the desired comfort in transient conditions; in other words by ensuring that, in the preceding relation,

B>>A

According to an aspect of the invention, the fixed term of the comfort index TCIs(t) at the instant t is obtained on the basis of the result of the heat exchanges in the passenger (BEs), which expresses at the instant t the difference between the flow of heat generated or absorbed by the body and the flow of heat that the body may give off toward the external environment while maintaining the body at its comfort temperature. The closer this term is to zero, the nearer the person is to equilibrium and thermal neutrality. To express the fixed term with a scale of values representative of the thermal perception, a calibration coefficient (Cs) is applied, such that:

TCIs(t)=Cs.BEs(t)

TCIs(t) varies between a minimum value, for example “−4”, corresponding to a “very cold” state, and a maximum value, for example “+4”, corresponding to a “very hot” state.

According to an aspect of the invention, the dynamic term TCId(t) of the comfort index at the instant t is estimated from the measurement or prediction of thermal imbalances STd(t), as a function of variations of heat flow rates or temperatures in certain areas of the passenger's body. The imbalance STd(t) may correspond to an uncomfortable thermal stress or to a comfortable thermal stimulus. Taking this into account in the calculation of the dynamic term TCId(t) results in the application of a calibration coefficient (Cd) and a damping term of the general form:

TCId(t)=Cd.exp[−(t−to)/tc].STd(t)

Depending on the nature and formulation of the thermal imbalance STd(t), the coefficient Cd will be negative or positive, so that the dynamic term TCId(t) is negative when it contributes to a perception of cold, and positive when it contributes to a perception of heat.

Depending on the nature and formulation of the thermal imbalance STd(t), the coefficient Cd will be calibrated so that it contributes to a worsening or an improvement of the comfort index, depending on whether the imbalance generates an uncomfortable, unpleasant local stress or a comfortable, pleasant local stimulus.

Depending on the nature and formulation of the thermal imbalance, the damping term exp[(t−to)/tc] will depend on the instant (to) of detection or generation of the imbalance, and on a characteristic time (tc) of the presence of, or allowance for, the thermal imbalance.

According to an aspect of the invention, the thermal imbalance STd(t) will be equal to a difference between a measured or estimated heat flow F(t) and a reference heat flow Fo(t), of the form:

STd(t)=[F(t)−Fo(t)]

According to another aspect of the invention, the thermal imbalance STd(t) will be equal to a difference between a temperature T(t) or a temperature difference ΔT(t) and a reference To(t) or ΔTo(t), of the form:

STd(t)=[T(t)−To(t)] or

STd(t)=[ΔT(t)−ΔTo(t)]

According to an aspect of the invention, the system is arranged so that the dynamic term acts in the management of comfort, via the comfort index and via the damping term, for a predetermined period of time only, the period being, for example, less than 20 minutes, notably less than 10 minutes, or 5 minutes.

According to an aspect of the invention, the total comfort index is found by the following relation:

TCI(t)=A.TCIs(t)+B.TCId(t)

TCI(t)=A.Cs.BEs(t)+B.Σi[Cdi.exp[−(t−toi)/tci].STdi(t)]

where:
TCI(t) is the total comfort index as a function of the time t
TCIs(t) is the fixed term of the total comfort index
BEs(t) is the result of the passenger's heat exchanges in fixed conditions at the instant t (in W/m2)
Cs is a calibration coefficient to make the fixed comfort index vary within a range representative of a thermal comfort scale, for example from −4 (very uncomfortable, cold) to +4 (very uncomfortable, hot)
TCId(t) is the dynamic term of the total comfort index, associated with one or more transient thermal imbalances
Σi expresses the sum of the contributions of different dynamic terms, each term being assigned an index i
STdi(t) represents the imbalance between a heat flow Fi(t), a temperature Ti(t) or a temperature difference ΔTi(t) and reference values Fio(t), Tio(t), ΔTio(t)
Cdi is a calibration coefficient whose sign and amplitude vary according to its contribution to the improvement or worsening of the thermal comfort index (TCI)
toi is the initial instant when the dynamic term i is detected and taken into account
tci is the characteristic time during which the dynamic term is taken into account:
   tci will be high (15 minutes to 1 hour) if it relates to a level of environmental conditions that diminish slowly
   tci will be less than 15 minutes if it relates to a transient stimulus for improving comfort
A and B are two weighting coefficients, intended to give a greater or lesser weight to the dynamic term with respect to the fixed term, depending on the context of use or the passengers' preference

According to an aspect of the invention, the thermal imbalance STd that acts in the dynamic term TCId is calculated on the basis of a measurement of thermal imbalance based on the temperature difference between prominent points of the face [ΔTVis].

For example, the thermal imbalance STd is calculated on the basis of the following formula:

ΣTδ(Σ)=ΔTVis(t)+B

where B is between 0.5 and 1.5

According to an aspect of the invention, the thermal imbalance ΔTVis is calculated on the basis of the temperatures measured at the prominent points of the passenger, for example the tip of the nose, the sum of the left or right cheekbone and the center of the forehead.

According to an aspect of the invention, the formula used is:

ΔTVis=Tnose−(Tcheekbone+Tcenter of forehead)/2, or

ΔTVis=Tnose−(Tcheekbone_left+Tcheekbone_right)/2

According to an aspect of the invention, the temperature of the prominent point is measured by merging images, notably taken by cameras, preferably NIR and FIR infrared cameras, enabling measurements to be made continuously when the passenger moves.

According to an aspect of the invention, when working with a comfort index TCI distributed over each part of the body, there can be an asymmetric evaluation of the dynamic term TCId, making it possible to act in different ways on the left and right sides of the passenger's body.

The invention also proposes, independently or in combination with the above, a method of thermal management for a motor vehicle interior, the method comprising the following steps:
preferably, determining a datum (MET) representative of the passenger's metabolic activity , notably by using an infrared sensor aimed toward the passenger,
determining two terms making up a value of a thermal comfort index (TCI) associated with this passenger in the interior,
   one of the terms being a fixed term (TCIs) representative of the heat exchanges required to maintain a stabilized state of thermal comfort in the passenger, with the aim of achieving thermal neutrality at the global and local level, notably obtained by means of a thermophysiological model, using, notably, the datum (MET) representative of the passenger's metabolic activity.
   the other of the terms being a dynamic term (TCId) representative of one or more local transient imbalances of the passenger's state of thermal comfort, resulting from:
   a recent thermal stress to which the passenger has been subjected,
   a thermal stimulus intended to provide a pleasant temporary sensation of heat or cold, particularly in order to compensate for a thermal stress as described above.
determining the value of a thermal comfort index (TCI) on the basis of the two terms thus determined,
controlling one or more thermal actuators on the basis of this thermal comfort index value.

The present invention is intended, notably, to use two families of sensors and two thermophysiological models for dynamically managing the thermal comfort of passengers, by combining, according to the context and requirements, a logic for maintaining thermal comfort which provides thermal neutrality with a logic for providing comfort, or reducing discomfort, by applying pleasant thermal stimuli.

The fixed thermal comfort index TCIs of a person may be evaluated on the basis of the evaluation of his metabolism MET, his clothing, and the thermal conditions of his environment.

His metabolism is found from the morphological characterization of the person (age, body mass index (BMI) of the passenger, gender), for example by means of one or more cameras and a class learning method, notably using “deep learning”, and the evaluation of his activity both by the recognition of gestural and vocal activity and by the measurement of vital signs such as the respiration rate and amplitude and the heart rate.

In order to be able to evaluate the effect of non-fixed conditions on a passenger's comfort, it is important both to know the dynamics of the variation of the temperatures of his various limbs and of his environment, comprising the seats, the instrument panel and the steering wheel for example, and to understand the temperature variations observed on his clothing or face.

By measuring the temperature of visible prominent points such as the tip of the nose, the cheekbones and the centers of the forehead, these prominent or characteristic points are located by merging between a precise, high-resolution NIR camera and a lower-resolution FIR camera.

A knowledge of this thermal imbalance makes it possible to define the setpoints of the air-conditioning unit, the heat and cold sources and the multi-sensory stimuli.

The invention will be better understood and other details, features and advantages of the invention will become apparent on reading the following description, which is given by way of non-limiting example with reference to the appended drawings, in which:

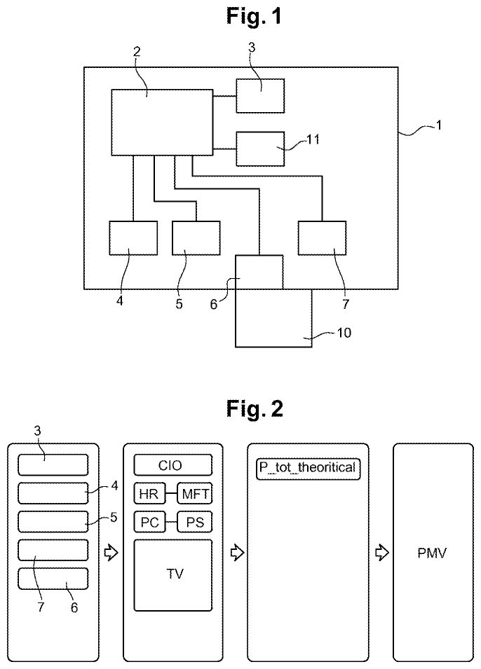

FIG. 1 shows, in a schematic and partial manner, a thermal system according to the invention,

FIG. 2 shows steps in the method of managing thermal comfort in the system of FIG. 1,

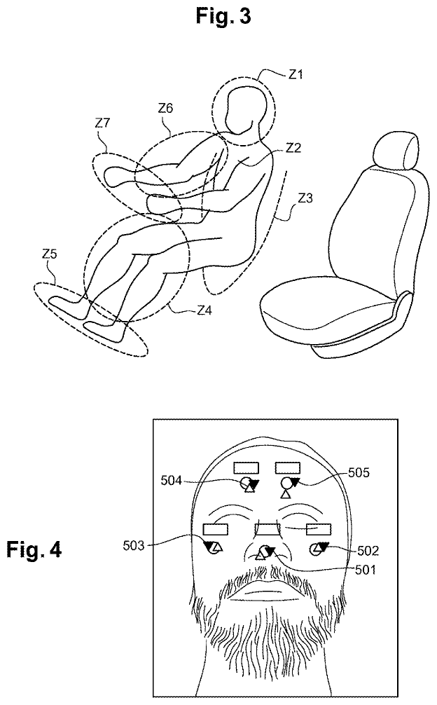

FIG. 3 shows the different areas of the passenger involved in the method of FIG. 2,

FIG. 4 shows the measurement of temperature on a passenger's face.

FIG. 1 shows a thermal management system 1 for a motor vehicle interior, the system comprising a processing unit 2 arranged for:
acquiring a first datum (CIo) representative of the level of clothing of a passenger in the interior,
acquiring a second datum (MET) representative of the passenger's metabolic activity,
acquiring a third datum representative of the thermal environment of the passenger in the interior,
acquiring a fourth datum representative of a thermal imbalance in one or more parts of the passenger's body, of the heat flow, temperature or temperature difference type,
determining a value of a thermal comfort index (TCI) associated with the passenger in the interior on the basis of the four data thus acquired.

The system comprises a plurality of sensors arranged for measuring a plurality of parameters used to determine the first, second, third and fourth data.

These sensors comprise:
a DMS camera 3 arranged for observing a passenger in the interior,
an infrared dome 4 formed by a wide angle infrared camera placed on a ceiling of the interior, for measuring the temperature of the walls of the interior and of some parts of the passengers' bodies,
a sun sensor 5,
at least one air temperature sensor 6 at the outlet of an air conditioning unit or of the HVAC 10,
at least one sensor for detecting the air flows and their distribution at the outlet of an air conditioning unit or of the HVAC 10,
at least one sensor of the current air temperature 7 in the interior;
preferably, a moisture sensor and temperature sensors arranged in some walls of the interior,
preferably, a sensor of the heat flow in the areas in contact with the passengers.

The system 1 is arranged to measure a parameter serving to determine the third datum representative of the thermal environment of the passenger in the interior, this parameter being related to the state of the air-conditioning device, notably to the power of a blower of the air-conditioning device or the distribution of conditioned air from the air-conditioning device.

The first datum (CIo) representative of the level of clothing of the passenger in the interior corresponds to a measured clothing insulation of the clothes worn by the passenger.

To this end, the system 1 is arranged to process an image taken by the camera 3 and to, from this image, determine the type of clothes (T-shirt and/or shirt and/or pullover and/or overcoat and/or scarf and/or hat) worn by the passenger, notably via image recognition, the system 1 furthermore being arranged to determine clothing insulation from the type of clothes thus measured.

The second datum (MET) representative of the passenger's metabolic activity is dependent on the respiratory activity and on the heart rate HR of the passenger, which are measured, notably, by the camera 3, as may be seen in FIG. 2.

This camera 3 is arranged to observe changes in the color of the face of the passenger due to the movement of blood under the skin of the face, and the system measures heart rate based on these images.

The second datum (MET) representative of the passenger's metabolic activity is dependent on a physical characteristic of the passenger, which is measured by the camera 6 to determine, by image processing, physical characteristics PC of the passenger, notably the sex, age, height and volume, and indirectly the weight, as well as his posture and movements.

The second datum (MET) representative of the passenger's metabolic activity corresponds to a surface heat power PS to be discharged to the outside by the passenger, deduced with the aid of the datum PC.

A plurality of data (MET) representative of the metabolic activity of the passenger are used.

The system 1 may also take into account the solar flux absorbed directly by the skin, which is then added to the surface power PS to be discharged.

The system 1 is arranged to compute, from the temperatures of the walls and/or window, which are measured by the infrared dome 4, the radiative temperature of a plurality of parts of the body of the passenger, such as his head Z1, chest Z2, back Z3, legs Z4, feet Z5, arms Z6 and hands Z7, as shown in FIG. 3.

The system 1 is arranged to estimate the temperature of the air making contact with a part of the body of the passenger, notably a plurality of parts of the body of the passenger, especially his head, chest, back, legs, calves, feet, and/or arms, especially based on the power of an air blower and/or of the distribution of the HVAC and/or of the temperature of the blown air and the temperature of the interior, especially on the basis of charts.

The system 1 is arranged, on the basis of the HVAC distribution and/or of the power of the air blower, to estimate, notably using charts, the speed of the air making contact with one part or a plurality of parts of the body of the passenger.

These temperatures and/or speeds TV are used to compute the third datum representative of the thermal environment of the passenger in the interior.

The system 1 is arranged to estimate the total heat power that can be exchanged (P_tot_theoritical) by the passenger with his environment with a skin temperature corresponding to said comfort level, by estimating the heat power exchanged part by part of the body, notably the head, the chest, the back, the legs, the calves, the feet and the arms. This total exchanged heat power (P_tot_theoritical) is a function of the data CIo and PC.

The powers exchanged are a function of the local air speed, the local air temperature, the local radiative temperature, the surface area of the passengers, and the level of clothing of the passenger (CIo).

The powers exchanged include an additional term associated with the heat given off by respiration, evaporation and perspiration, which is a function of, among other things, the second datum (MET) representative of the passenger's metabolic activity.

The system 1 is arranged for comparing the total heat power that can be exchanged with the environment at the comfort level of the skin temperature (P_tot_theoritical) with the power generated by the passengers' metabolism, to which the absorbed solar flux is added if appropriate, and, by multiplying this difference in power by a coefficient, determining a value of the thermal comfort index (TCI).

According to an aspect of the invention, this model can then be used to estimate the instantaneous comfort of the passengers. Set points may also be defined for the thermal actuators in order to ensure passenger comfort. Thus personalized regulation of the thermal system is obtained.

The method is able to take into account heat exchange by respiration, sweating and perspiration, which depends on the ambient humidity and temperature and on metabolism, to estimate a comfort index.

Metabolic activity is determined depending on the date and/or time, sex, age and other personal characteristics of the passenger, and on the datum or knowledge of their current or previous activities.

A thermal management system for a motor vehicle interior will now be explained with reference, notably, to FIG. 4, the system comprising a processing unit 2 arranged for:
determining a datum (MET) representative of the passenger's metabolic activity, notably by using an infrared sensor aimed toward the passenger,
determining two terms making up a value of a thermal comfort index (TCI) associated with this passenger in the interior,
   one of the terms being a fixed term (TCIs) representative of the heat exchanges required to maintain a stabilized state of thermal comfort in the passenger, with the aim of achieving thermal neutrality at the global and local level, notably obtained by means of a thermophysiological model, using, notably, the datum (MET) representative of the passenger's metabolic activity.
the other of the terms being a dynamic term (TCId) representative of one or more local transient imbalances of the passenger's state of thermal comfort, resulting from:
   a recent thermal stress to which the passenger has been subjected,
   a thermal stimulus intended to provide a pleasant temporary sensation of heat or cold, particularly in order to compensate for a thermal stress as described above.
determining the value of a thermal comfort index (TCI) on the basis of the two terms thus determined,
controlling one or more thermal actuators on the basis of this thermal comfort index value.

The fixed term TCIs is representative of a state of thermal neutrality for the passenger, a comfort state characterized by the absence of any thermal sensation, that is to say neither heat nor cold, at both the global and the local level, and associated, notably, with the long-term maintenance of comfort.

The dynamic term TCId is representative of a state in which the passenger is subjected to transient thermal stimuli, that is to say a local unbalancing of the heat exchanges, revealing a thermal stress that has been undergone, or intended to provide a temporary hot or cold sensation to compensate for thermal stress or discomfort existing previously or in other areas.

The positive stimuli are associated with a situation chosen from among:
a recent prior event, for example a journey on foot that has just ended, or a walk in a very cold environment,
a sudden variation in the thermal environment; for example, the passenger enters an overheated vehicle in the summer, or the sun suddenly shines on the passenger's head,
a thermal stress due to a psychophysiological shock, for example when the passenger has just avoided an accident.

The present invention is intended to provide a solution for better identification and management of these different situations over time, on the basis of signs in a person that can be detected and interpreted.

According to an aspect of the invention, the system is arranged for estimating a value of a comfort index for all the passengers in a vehicle, using an infrared camera, notably a plurality of infrared cameras. These cameras are described in relation to the preceding embodiment.

An active infrared camera operating in the near infrared (Near Infra Red camera), or a passive camera operating in the far infrared (Far Infra Red), is provided.

The fixed term of the comfort index TCIs is found using an energy balance model, partly derived from Fanger's model. The closer this term is to zero, the nearer the person is to thermal neutrality.

The dynamic term TCId of the comfort index is estimated from thermal imbalances applied to, or undergone by, the passenger. This term may take a value of more or less than zero, depending on the direction (heating or cooling) and intensity of the thermal stimulus undergone or applied.

According to an aspect of the invention, the system is arranged so that the dynamic term acts in the management of comfort, via the comfort index, for a predetermined period of time only, the period being, for example, less than 20 minutes, notably less than 10 minutes, or 5 minutes.

The total comfort index is found using the following relation:

TCI(t)=TCIs+Alpha (1-exp(−t/E))*TCId

where
TCI(t) is the global comfort index as a function of the time t
TCIs is the fixed term of the comfort index
TCId is the dynamic term of the comfort index

Alpha is between 1 and 4, for example

E=3 to 15 minutes, for example

The dynamic term TCId is calculated on the basis of a measurement of thermal imbalance ΔT.

The dynamic term TCId is calculated on the basis of the following formula:

TCId=A ΔT+B
where A is between 0.4 and 0.6
B is between 1 and 1.5

The thermal imbalance ΔT is calculated on the basis of the temperatures measured at the prominent points of the passenger, for example the tip of the nose 501, the sum of the left cheekbone 502 or right cheekbone 503 and the center of the forehead 504 and 505, as illustrated in FIG. 4.

The formula used is:

ΔT=Tnose−(Tcheekbone+Tcenter of forehead)/2

or

ΔT=Tnose−(Tleft_cheekbone+Tright_cheekbone)/2

According to an aspect of the invention, the temperature of the prominent point is measured by merging images, notably taken by cameras, preferably NIR and FIR infrared cameras, enabling measurements to be made continuously when the passenger moves.

1. A thermal management system for a motor vehicle interior, the system comprising:
a processing unit arranged for:
determining a datum (MET) representative of a passenger's metabolic activity, using an infrared sensor aimed toward the passenger;
determining two terms making up a value of a thermal comfort index associated with the passenger in the motor vehicle interior,
one of the two terms being a fixed term (TCIs) representative of the heat exchanges required to maintain a stabilized state of thermal comfort in the passenger, obtained using a thermophysiological model and the datum (MET) representative of the passenger's metabolic activity,
the other of the two terms being a dynamic term (TCId) representative of one or more local transient imbalances of the passenger's state of thermal comfort, resulting from a recent thermal stress to which the passenger has been subjected,_or a thermal stimulus intended to provide a pleasant temporary sensation of heat or cold;
determining the value of the thermal comfort index (TCI) on the basis of the two terms; and
controlling one or more thermal actuators on the basis of the thermal comfort index value.

2. The system as claimed in claim 1, wherein the fixed term is representative of a state of thermal neutrality for the passenger, a comfort state characterized by the absence of any thermal sensation, that is to say neither heat nor cold, at both a global and a local level, and associated with the long-term maintenance of comfort.

3. The system as claimed in claim 1, wherein the dynamic term is representative of a state in which the passenger is subjected to transient thermal stimuli, comprising a temporary local unbalancing of the heat exchanges that provides a temporary sensation of heat or cold.

4. The system as claimed in claim 1, wherein the thermal stresses and stimuli are associated with a situation chosen from among:
a recent prior event in a cold environment,
a sudden variation in the thermal environment, and
a thermal stress due to a psychophysiological shock.

5. The system as claimed in claim 1, wherein the system is arranged for estimating a value of a comfort index for all the passengers in a vehicle, using a plurality of infrared cameras.

6. The system as claimed in claim 5, wherein the plurality of infrared cameras are active infrared cameras operating in the near infrared, or passive cameras operating in the far infrared.

7. The system as claimed in claim 1, wherein the thermal comfort index TCI is defined on the basis of the fixed term TCIs and the dynamic term TCId by the weighted sum of the two terms:
TCI=A.TCIs+B.TCId

8. The system as claimed in claim 1, wherein the fixed term at an instant t of the total comfort index is found by the following relation:
TCIs(t)=Cs.BEs(t)
where:
TCIs(t) is the fixed term of the total comfort index,
BEs(t) is the expression of the result of the passenger's heat exchanges in fixed conditions at the instant t (in W/m2),
Cs is a calibration coefficient to make the fixed term of the comfort index vary within a range representative of a thermal comfort scale, for example from −4 to +4.

9. The system as claimed in claim 1, wherein the dynamic term TCId at an instant t of the total comfort index is found by the following relation:
TCId(t)=Σi[Cdi.exp[−(t−toi)/tci].STdi(t)]
wherein:
TCId(t) is the dynamic term of the total comfort index,
Σi expresses the sum of the contributions of different transient thermal imbalances, each term being assigned an index I,
STdi(t) represents the imbalance between a heat flow Fi(t), a temperature Ti(t) or a temperature difference ΔTi(t) and reference values Fio(t), Tio(t), ΔTio(t),
Cdi is a calibration coefficient whose sign and amplitude vary according to its contribution to the improvement or worsening of the total thermal comfort (TCI),
toi is the initial instant when the dynamic term i is detected and taken into account,
tci is the characteristic time during which the dynamic term is taken into account:
tci will be high at 15 minutes to 1 hour if it relates to a level of environmental conditions that diminish slowly, and
tci will be less than 15 minutes if it relates to a transient stimulus for improving comfort.

10. The system as claimed in claim 9, wherein the thermal imbalance STd that acts in the dynamic term TCId is calculated on the basis of a measurement of thermal imbalance based on the temperature difference between prominent points of the face [ΔTVis].

11. The system as claimed in claim 10, wherein the thermal imbalance STd is calculated on the basis of the following formula:
ΣTδ=ΔTVis+B
where B is between 0.5 and 1.5, and
ΔTVis=Tnose−(Tcheekbone+Tcenter of forehead)/2
or
ΔTVis=Tnose−(Tcheekbone_left+Tcheekbone_right)/2

12. A method of thermal management for a motor vehicle interior, the method comprising:
determining a datum (MET) representative of the passenger's metabolic activity, using an infrared sensor aimed toward the passenger;
determining two terms making up a value of a thermal comfort index (TCI) associated with this passenger in the interior,
one of the terms being a fixed term (TCIs) representative of the heat exchanges required to maintain a stabilized state of thermal comfort in the passenger, obtained using a thermophysiological model, and the datum (MET) representative of the passenger's metabolic activity,
the other of the terms being a dynamic term (TCId) representative of one or more local transient imbalances of the passenger's state of thermal comfort, resulting from:
a recent thermal stress to which the passenger has been subjected, or a thermal stimulus intended to provide a pleasant temporary sensation of heat or cold;
determining the value of the thermal comfort index (TCI) on the basis of the two terms; and
controlling one or more thermal actuators on the basis of the thermal comfort index value.
